(19) United States
(12) Patent Application Publication
(10) Pub. No.: US 2023/0418957 A1
(43) Pub. Date: Dec. 28, 2023

(54) PROVIDING PROGRAMS FOR CONTROL DEVICES OF TECHNICAL EQUIPMENT

(71) Applicant: Lenze SE, Aerzen (DE)

(72) Inventors: Werner Paulin, Worpswede (DE); Darius Felski, Lilienthal (DE); Christian Sporer, Bremen (DE)

(73) Assignee: Lenze SE, Aerzen (DE)

(21) Appl. No.: 18/342,800

(22) Filed: Jun. 28, 2023

(30) Foreign Application Priority Data
Jun. 28, 2022 (DE) 10 2022 116 086.6

(51) Int. Cl. G06F 21/60; G05B 19/04

(52) U.S. Cl. CPC G06F 21/604; G05B 19/04

(57) ABSTRACT

The invention relates to a method for providing programs (12, 14) for control devices of technical equipment (26, 28), in particular machinery and/or plants, wherein, in particular, programs (12, 14) for control devices of electric drive systems are provided. The programs (12, 14) are provided in a software memory (10) managed by software memory management software, wherein the software memory management software comprises access rights management. The access rights of users (30, 32, 34) to access the programs (12, 14) are managed in the managed software memory (10) by means of the access rights management. Users (30, 32, 34) are granted access rights which enable the users (30, 32, 34) to store programs (12, 14) created, in particular by means of a development environment, in the managed software memory. Users (30, 32, 34) are further granted access rights, in particular by a user (30, 32, 34) authorized for this purpose, said access rights enabling the users (30, 32, 34) to use specific programs (12, 14) provided in the software memory (10), in particular to transfer a copy of a specific program (12, 14) provided in the managed software memory (10) onto a control device of technical equipment (26, 28).

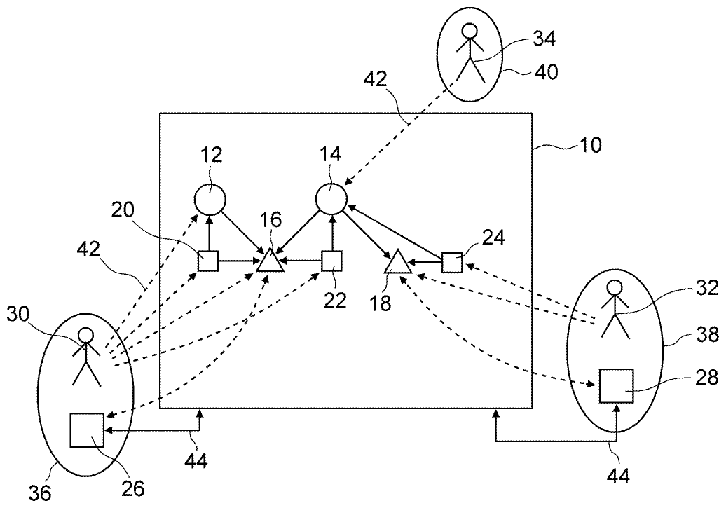

### TECHNICAL FIELD

The system described herein relates to providing programs for control devices of technical equipment, such as machinery and/or plants.

### BACKGROUND

Modern control devices, also referred to, in particular, as programmable logic controllers, are enabled using software to perform technical tasks as a component of respective technical equipment. The software of a control device of this type usually includes a plurality of programs. As a rule, the programs are created individually using special software development tools for individual pieces of technical equipment. Individual characteristics of the respective technical equipment or the respective control device are taken into account. Particularly in the case of machinery and/or plants which are highly specialized in terms of the specific needs of an individual case of application, this means as a rule that the software for the respective technical equipment must be kept available and maintained individually throughout the lifetime of the technical equipment.

In practice, pieces of technical equipment often perform similar tasks and are correspondingly very similar in terms of technical design and, in particular, the technical design of control devices of the technical equipment, but the technical equipment differs in terms of details which rule out the shared use of one program on two similar, but not identical, pieces of technical equipment.

In addition, both the technical equipment itself and the programs are subject to changes during the lifetime of technical equipment. Programs of individual pieces of technical equipment are adapted, for example, as a result of conversions of the technical equipment and/or changes in the requirements for the functionalities of the respective technical equipment. As a result, the programs of two pieces of technical equipment which are mutually compatible at a certain time can develop “along divergent paths”.

The resulting solution of keeping available the programs for each individualized piece of technical equipment throughout the lifecycle of the technical equipment in such a way that the technical equipment can be updated and adapted if required generates a huge administrative workload in practice with respect to the so-called lifecycle management of technical equipment of the type concerned.

### SUMMARY OF THE INVENTION

It is desirable therefore to provide a mechanism for providing programs which enables efficient lifecycle management for a plurality of pieces of technical equipment in term of the programs used by the control devices of the technical equipment.

Managed software memories of the type concerned are also referred to as a software repository. The managed software memory is managed by software memory management software. In particular, the managed software memory enables the respective associated components of a program managed in the managed software memory to be managed and/or assigned to one another as a coherent entity. Alternatively and/or additionally, the software memory further enables, in particular, assignments between different entities and/or files and/or data assigned to the different entities. This is advantageous in particular if a program consists of a plurality of files, for example an executable program and associated further data, and/or if supplementary information is stored for a program and/or if the program is intended to be assigned to specific other entities, for example digital representations of technical equipment.

The programs can accordingly be, in particular, application programs executable on the control device. The technical equipment is, in particular, a machine and/or plant. The application programs can contain executable program code, for example in the form of an executable program file and/or other data, particularly in the form of files that can be processed by the control device and/or the software of the control device.

The software memory management software includes, in particular, access rights management. The system described herein provides for the access rights of users to access the programs in the managed software memory to be managed using the access rights management. Using the access rights management can ensure in particular that changes to programs through access by unauthorized users are prevented. User management can provide management of user groups. In this context, user management can provide, in particular, that users can be assigned to one and/or more user groups. User management can provide for rights of access, in particular, to individual entities stored in the managed software memory, for example to individual programs, to be granted and/or denied to users belonging to a specific group. User groups belonging to a specific company or a specific department in a company, for example, can be defined.

The system described herein provides for access rights enabling users to store programs in the managed software memory to be granted to users for the development of the programs. The programs can be created, in particular, using a development environment. In this context, the system described herein can provide for access to a development environment to be granted to users.

The system described herein can provide for the programs to be intended for execution using container virtualization. The container virtualization can be the container virtualization Docker. In this context, the system described herein can provide for a check to be carried out by the software memory management software to determine whether the programs are intended for execution using container virtualization. The check can include, in particular, a check to determine whether the programs have a specific file format. In this context, the system described herein can provide, in particular, for the programs to be provided only depending on the result of the check.

Users are thus initially enabled to develop programs and store the programs in the managed software memory. In this way, for example, software developers of a company can be enabled to develop a program for specific technical equipment.

The system described herein can further provide for access rights to be granted to users which enable the users to use specific programs stored in the software memory. The access rights can include, in particular, the authorization to transfer a copy of a specific program provided in the managed software memory onto a control device of technical equipment. In this context, the system described herein can provide, in particular, for the access rights to be granted to users by a user authorized to grant access rights. In this context, the user authorized to grant access rights can be, in particular, the user who stored the program in the managed software memory.

Using the system described herein to provide programs, appropriate lifecycle management is enabled in that software developers can create the programs and store the programs in the managed software memory, while other users are given the facility to transfer copies of the managed programs onto control devices. This can, for example, enable employees of software companies to provide programs for technical equipment in the managed software memory, and employees of operator companies of technical equipment to transfer copies of the programs stored in the managed software memory onto control devices of the employees of operator companies. The managed software memory can thus serve as a type of central exchange location for the programs. In connection with user management, different providers of programs are enabled, in particular, to make the programs available to different operators of technical equipment, where a flexible assignment of the respective access rights can be implemented.

The programs can in each case include a binary file. Alternatively and/or additionally, the programs can in each case consist of a binary file. The binary file can be a binary file with machine code and/or byte code. Binary files with machine code and/or byte code are also referred to as machine programs. Binary files with machine code and/or byte code can be executed directly by the control device, in particular by a processor of the control device. The advantage of providing programs in the form of binary files in the managed software memory lies, in particular, in the ability to make an identical version of the program available, even over long time periods. On principle, a source code, for example, can likewise be kept available over a lengthy period, but the source code still needs to be compiled before being used on the control device. If it is necessary, for example, to reload a program onto a control device following a conversion, a modification of the compiler that is used can result in modifications in the resulting binary file, possibly rendering the resulting binary file unusable. By contrast, the risk of generating an unusable binary file from source code does not exist in the case of providing programs in the form of binary files, since the binary files can be used by the control device directly or in unmodified form.

The system described herein can provide for the programs to be managed in the managed software memory in such a way that programs can be defined as completed following completion of the programs. The system described herein can provide, in particular, that a program can be defined as completed only by a user authorized to define a program as completed. In this context, the system described herein can provide that the corresponding authorization can be granted to a plurality of users and/or to a user group.

The facility to define programs as completed in the managed software memory enables the programs to be differentiated from other programs which are still in development and which, as a result, are to be expected to be subject to modification in future. Particularly if the programs include a binary file, the basis is thus provided for the desired long-term usability of unmodified programs for control devices.

The system described herein can provide, in particular, for the programs to be managed in the managed software memory in such a way that programs defined as completed cannot be modified. If it is ensured that programs defined as completed cannot be modified, a user of programs defined as completed can always assume that the programs are an unmodifiable software version. With regard to the use of the programs in control devices of technical equipment, long-term availability of a program in an unmodified state is thus enabled in the context of lifecycle management.

In other words, through the definition of a program as completed, the current version of the program is “frozen”. Further development of a program defined as completed can, on principle, be enabled by the system described herein, but the result is then, in particular, the generation of a new program instead of a modification of the program defined as completed. The provision of different versions of a program can be enabled, for example, by storing information assigned to a program, in particular, in the managed software memory and/or using the software memory management software, the information characterizing a new program as a different version of a different program.

The system described herein can provide, in particular, for the programs to be managed in the managed software memory in such a way that only copies of programs defined as completed can be transferred from the managed software memory onto control devices of technical equipment. This can ensure that no “delivery” of programs which are still subject to changes during a development process will take place. Manufacturers of technical equipment are thereby prevented from mistakenly using different versions of a program in control devices.

Alternatively and/or additionally, the system described herein can provide that copies of programs not defined as completed can be transferred from the managed software memory onto technical equipment only under conditions defined separately for transferring programs. A transfer of programs not defined as completed under separately defined conditions can, for example, enable a use of the programs on a control device for experimental purposes. The separately defined conditions can, for example, be a special access authorization of a user to transfer copies of programs not defined as completed and/or of a specific program defined as not completed. In this context, the system described herein can provide that the special access authorization can be granted to a plurality of users and/or to a user group. Alternatively and/or additionally, the system described herein can provide that the special access authorization is granted to the user only for a limited time period and/or only until a specific point in time. In this context, the system described herein can provide that the special access authorization can be granted only by a user authorized to grant the special access authorization. The system described herein can provide that an authorized user can set the time period and/or the point in time, in particular within predefined limits.

The system described herein can provide for the programs to be managed in the managed software memory in such a way that programs can be defined as discontinued. The facility to define programs as discontinued also enables the organizational mapping of the end of a lifecycle of a program to be managed in an appropriate manner with the system described herein. In this context, the definition as discontinued represents, in particular, only the instigation of a “phasing-out process” of the respective program. A situation, for example, in which programs are “surprisingly” no longer available can thereby be prevented.

The system described herein can provide, in particular, that a program can be defined as discontinued only by a user authorized to define a program as discontinued. In this context, the system described herein can provide that the corresponding authorization can be granted to a plurality of users and/or to a user group.

The programs can be managed in the managed software memory in such a way that copies of discontinued programs can be transferred from the managed software memory onto technical equipment only until a point in time set for the respective program. A kind of “grace period” can thus be provided in which the programs are still available following discontinuation of the programs. In this way, users of older programs, for example, can be given the facility to find out in a timely manner about possible compatible programs which the users can use in future, and to qualify the possible compatible programs, particularly in a timely manner for use in series production before the older program is no longer available.

The system described herein can provide, in particular, for a notification of the discontinuation to be issued to users. The users can, in particular, be users who have transferred the respective affected program onto a control device, in particular following discontinuation of the respective affected program. The notification can be issued, in particular, on the technical equipment, for example on a user interface of the technical equipment, in particular of the control device, and/or a user interface connected to the technical equipment, in particular to the control device. The user interface can be a display. Supplementary information, in particular relating to the discontinuation and/or to a successor version, can be made available to the user with the notification. Alternatively and/or additionally, the system described herein can provide for notifications with information relating to programs used by users to be also issued in connection with events other than the discontinuation of the respective program, in particular where the user can define the programs for which the users would like to receive the notifications.

The system described herein can provide for users to be granted access to the managed software memory enabling the creation of digital representations of individual pieces of technical equipment in the managed software memory. Digital representations of individual pieces of technical equipment in the managed software memory are also generally referred to as “digital twins”, in other words the digital representation can be a digital twin. The digital representation can be created, in particular, using planning software for the planning of technical equipment.

The system described herein can further provide for users to be granted access to the managed software memory which access enables programs stored in the managed software memory to be assigned to a digital representation of technical equipment. In this context, the assignment of a program to technical equipment is also, in particular, a use of the program within the meaning of the system described above, where a corresponding authorization of the user is required.

The facility for such an assignment of the programs to digital representations of individual pieces of technical equipment in the managed software memory enables users to select the programs for technical equipment in the first instance only within the managed software memory. This process is therefore decoupled from the loading of the software onto the actual control device. The selection and assignment of the programs can thus take place, for example, in a planning phase, and/or, during the ongoing operation of existing technical equipment, modifications to the software of the equipment can be planned and/or prepared.

The system described herein can provide, in particular, that the creation of a digital representation and/or the assignment of a program to a digital representation of technical equipment can be performed only by a user authorized for the creation of a digital representation and/or the assignment of a program to a digital representation of technical equipment. In this context, the system described herein can provide that the corresponding authorization can be granted to a plurality of users and/or to a user group.

The system described herein can provide for the programs to be managed in the managed software memory in such a way that description files can be stored in the managed software memory, where the description files can be assigned in each case to a digital representation of technical equipment and to a program assigned to the digital representation, and contain information relating to the programs which is processable by the control device of the technical equipment.

The description file can contain information stored in a format which is readable by the control device and is important for the execution of a respective program. On principle, all types of information which can be of use “in situ” on the control device can be stored in the description file. The information can then be processed by the control device, in particular to enable and/or support the execution of the program on the control device. The advantage of using the description file is gained, in particular, in connection with a program including a binary file. Information can thus be stored comparatively “transparently” in the description file, whereas, in the case of a binary file, it is extremely difficult for a human user to read information from a binary file. Alternatively and/or additionally, however, a binary file can also be stored as a description file, for example an AI model and/or a database. In addition, due to the facility to provide different authorizations to access a program on one hand and a description file on the other hand, specific adaptation facilities can be provided in a targeted manner for the user without modifying the program itself. In other words, the authorizations to access programs, digital representations and/or the description files can be managed, in particular, independently of one another. Managing authorizations independently enables users, in particular, to create programs and can further enable other users to create digital representations of technical equipment of the other users and to assign the programs to the other users. In order to provide the other users with the facility to adapt the programs, in particular in terms of communication with the technical equipment or the control device of the technical equipment, to the equipment/device, the other users can be granted access to the description files which enables the other users to adapt the corresponding description files.

The description file can be a file in a markup language, for example the Extensible Markup Language or, in other words, an .XML file. The system described herein can alternatively and/or additionally provide for a plurality of description files to be assigned to one program. The description files can be grouped in directories. Alternatively and/or additionally, description files can be provided which the respective program can access, create, modify and/or delete.

The facility exists, for example, to use description files described herein to ensure the compatibility of a binary file, in particular of an executable program in the form of a binary file, with different control devices.

The information relating to the programs can include, in particular, port numbers and/or port mapping. The port numbers and/or the port mapping are transferred to the program, in particular, during the execution of the program by the control device. It can thus be ensured that, during the execution of a program on a control device, only permitted ports are opened by the program. In this context, the programs can initially have default values for the ports and/or the port mapping which, particularly in connection with access to the digital representation, can be adapted for the respective use of the program. As a result, for example, the use of the same port which two programs in each case have as the default value can be prevented if the two programs are used on the same control device.

The port number(s) which is/are correct for communication with the control device can be transferred to the program and used by the program.

The information relating to the programs can include, in particular, values of environmental variables. The values of the environmental variables are transferred to the program, in particular, during the execution of the program by the control device. In this context, the programs can initially have default values for the environmental variables which, particularly in connection with access to the digital representation, can be adapted for the respective use of the program. The values for the environmental variables can, for example, be the destination addresses for communication with an external server. A further advantage of using the environment variables is that a user who uses a program can identify the ports that are used by accessing the description file and is thus informed of the communication paths used by the program or of the communication behavior of the program.

The system described herein can provide that, in response to a request, all of the programs assigned to the digital representation of technical equipment are synchronized with the copies of the programs stored in the control device of the technical equipment. In this context, the system described herein can provide, in particular, that, in response to the request and/or to a separate request, likewise the description files assigned to the programs and to the digital representation are synchronized with the copies of the description files stored in the control device of the technical equipment.

The synchronization described above can provide, in particular, the transfer of copies of programs and/or description files onto the control device, but also the removal of programs and/or description files from the control device which are no longer assigned to the digital representation of the technical equipment.

The system described herein can provide in particular that the synchronization can be carried out only through a request from an authorized user. In this context, the system described herein can provide that the corresponding authorization can be granted to a plurality of users and/or to a user group.

The synchronization is carried out, in particular, via a data connection between the control device and the managed software memory. The system described herein can provide for the data connection to be set up for the purpose of carrying out the synchronization. The data connection can be set up indirectly, for example using a gateway.

The facility to carry out a synchronization described herein offers a simple function little prone to errors for updating, supplementing and/or restoring the programs of the technical equipment.

If the description files are also included in the synchronization, this ensures, for example, that, if new and/or more up-to-date programs are loaded onto the control device, any new or up-to-date description files that may be required for synchronization are also transferred or updated. It also becomes possible, for example, for the programs available on the control device to be adapted by a user in line with modifications to the control device.

If, for example, a modification to the control device of technical equipment results in changes which require different values for the environmental variables so that the programs can continue to be executed on the control device of the technical equipment concerned, using the system described herein the user can adapt the values of the environmental variables in the description files which are assigned to the digital representation of the technical equipment and to the programs assigned to the digital representation and can then request synchronization of the programs and the description files.

In this way, the programs are then available to the user once more on the control device and are adapted thereto. One significant advantage is that the user can adapt programs independently of the control device itself. If, for example, a control device is modernized, the user can make the necessary adaptations of the description files independently of work carried out on the control device itself. Any idle times or outage times are advantageously shortened by decoupling of the adaptation of the software and possible interventions on the control device itself.

The programs can be managed in the managed software memory in such a way that programs can be defined as public by an authorized user, as a result of which the programs can be used by all users. Users are thus enabled to make programs of the users available to other users. Software developers, for example, can use the system described herein in this way to offer and distribute the programs developed by the software developers. In this context, the system described herein can provide, in particular, that programs can be defined as public by an authorized user only if the programs are defined as completed.

The programs can be managed in the managed software memory in such a way that programs can be defined as “group-public” for a specific user group, as a result of which the programs can be used by users of the specific user group. Users are thus enabled to make programs available to other users.

Software developers, for example, can use the system described herein to offer and distribute the programs developed by the software developers to a specific user group. Programs defined as group-public can thus be made available for use, for example, in a targeted manner only to the employees of a specific company and/or a specific organizational unit within a company.

Alternatively and/or additionally, specific customer groups could be defined as user groups in order to enable the specific customers to use specific programs. In this context, the system described herein can provide, in particular, that programs can be defined as group-public by an authorized user only if the programs are defined as completed.

Particularly in the context of management of the programs in the managed software memory which takes place in such a way that programs defined as completed cannot be modified, it can be ensured that only completed programs are released and released programs are not subsequently changed.

The programs can be managed in the managed software memory, in particular, in such a way that a program can be defined as public and/or group-public only if the software memory management software establishes that specific software components contained in the program and/or assigned to the program are present. It can be ensured in this way that programs can be made available to larger user groups only if specific information or components of the program is/are present. This can be verified, in particular, by the software memory management software in such a way that the presence of specific software components, in particular files or information stored in files which are components of the program or are assigned to the program, is verified in the managed software memory. The software components the presence of which is verified can be one or more of the following software components:
a name of the program;
a unique designation of the program, in particular selected according to a predefined scheme;
a version designation;
an executable program file, in particular in the form of binary code;
a value indication assigned to the program;
a description of the new features of the version of the program;
a brief description;
a detailed description.

In this context, the system described herein can provide, in particular, that the program can be defined as group-public only if the name, the unique designation, the version designation and the executable program file are present. Alternatively and/or additionally, the system described herein can provide, in particular, that a program can be defined as public only if all of the software components listed above are present.

The system described herein can provide, in particular, that information stored in the software components is made available to the users authorized to use the program. It can be ensured in this way that the users can obtain sufficient information relating to the programs before the users use the programs.

The programs can be managed in the managed software memory in such a way that value indications assigned to the programs are used in order to enable a commercial exploitation of the programs.

Particularly in connection with the definition of a program as group-public and/or public, the system described herein can be properly used as a distribution channel by offering programs to the public on a commercial basis. Alternatively and/or additionally, however, it is also possible to carry out a quantitative and/or time-based assessment of the use of the programs by users. Particularly in connection with value indications assigned to the programs, billing for the use of the program and therefore a scalable commercial exploitation can be implemented.

The system described herein can provide, in particular, for programs to be provided for control devices of electric drive systems. The control device of the technical equipment can, in particular, be a control device of an electric drive system of the technical equipment. Precisely in the case of drive systems of technical equipment of this type, a wide variety of designs prevails, but at the same time the tasks which different drive systems have to perform are similar. A wide variety of different electric motors, transmissions, sensors and actuators and control devices is used within the drive systems. The system described herein is therefore especially advantageous for providing programs for drive systems described herein in that it can be ensured on one hand that programs are available in the long term in unmodified form and, on the other hand, it is possible to adapt a program in a simple manner to individual technical equipment, in particular through adaptation of the description files. The “mass customization” enabled by the system described herein is therefore advantageous precisely for control devices of electric drive systems of the technical equipment concerned.

Also, due to the high flexibility of user management, a platform can be created on which, for example, IT service providers can offer highly specialized program solutions and distribute the solutions to customers in exactly the same way that manufacturers of drive systems can provide programs for extensive product ranges of the manufacturers of drive systems. At the same time, highly specialized mechanical engineers who manufacture highly individualized technical equipment can draw from a large pool of available programs for control devices and can adapt the available programs, in particular through manipulation of the description files, to individual needs. At the same time, providers of mass-produced technical equipment can supply large quantities of technical equipment in a simple manner with required programs due to the high degree of scalability of the system described herein.

### BRIEF DESCRIPTION OF DRAWINGS

Further practical embodiments and advantages of the system described herein are set forth below in connection with the drawing.

The sole FIGURE shows a schematic representation of an example of the system described herein.

### DETAILED DESCRIPTION OF VARIOUS EMBODIMENTS

The sole FIGURE illustrates, by way of example, the assignment of description files to programs and to digital representations of technical equipment in a managed software memory 10.

By way of example, two programs 12 and 14 and two digital representations 16 and 18 of technical equipment are stored in the managed software memory 10. As in the example shown, the programs 12 and 14 can be assigned, for example, to the digital representation 16. The program 14 is assigned only to the digital representation 18. As in the example shown, the system described herein can provide for description files 20, 22 and 24 to be stored in the managed software memory 10. By way of example, the description files are assigned in each case to a program and to technical equipment to which the program is assigned. Thus, in the example shown, the description file 20 is assigned to the program 12 and to the digital representation 16. The description file 22 is assigned, for example, to the program 14 and to the digital representation 16, whereas the description file 24 is assigned, for example, to the program 14 and to the digital representation 18. The description files can thus be adapted accordingly in order to enable the compatibility of the programs 12 and 14 with the control devices represented by the representations 16 and 18.

The scenario shown by way of example in the sole FIGURE further includes the technical equipment 26 and 28 and the users 30, 32 and 34. In the example illustrated, the users 30, 32 and 34 are, for example, employees of different companies 36, 38 and 40.

In the scenario shown by way of example, the system described herein is used to provide programs 12 and 14 for control devices of technical equipment 26 and 28, which can be machinery and/or plants.

The programs 12 and 14 are provided in a software memory 10 managed by software memory management software. The software memory management software includes access rights management.

The access rights of exemplary users 30, 32 and 34 to access the programs 12 and 14 can be managed in the managed software memory using the access rights management.

In the example shown, access rights 42 are granted to the users 30 and 34 for the development of the programs 12 and 14, the access rights 42 enabling the users 30 and 34 to store the programs 12 and 14 in the managed software memory.

In the scenario shown by way of example, the user 34 can, for example, be an employee of a software company who creates programs and makes the programs available in the managed software memory to other users for use by the other users. The user 30 is, for example, an employee of a company 36 which operates technical equipment 26. In the example shown, however, the employee 30 is also a software developer and correspondingly develops a program 12 and stores the program 12 in the managed software memory.

The user 32 is, for example, likewise an employee of a company 38 which operates technical equipment 28. In the example shown, however, the employee 32 does not create programs for any technical equipment.

The system described herein then provides, for example, access rights to be granted to users 30, 32 and/or 34 which enable the users to transfer a copy of a program 12 and/or 14 provided in the managed software memory onto a control device of technical equipment 26 and/or 28.

The actual transfer of the copy of the program provided in the software memory can be performed, for example, via a data connection 44 with which the respective technical equipment or a control device of the technical equipment is connected to the managed software memory 10.

This can advantageously be implemented by the system described herein, for example in that the user 34 assigns the program 12 of the user 34 to the digital twin 16. For this purpose, the system described herein can provide for the corresponding authorization to be granted to the user 34 to assign the program 12 stored by the user 34 in the managed software memory 10 to a digital representation 16 of the technical equipment 26 created by the user 34 in the managed software memory 10.

Further, as in the example shown, an access right can be granted to the user 30 to access a description file 20 which is assigned to the program 12 and to the digital representation 16 to which the program 12 is assigned. The user 30 can adapt the description file 20 due to their access right.

The system described herein can then advantageously provide that copies of programs can be transferred onto control devices of technical equipment only if the respective program is defined as completed. The user 30 can then, for example, define the program 12 as completed. However, the system described herein advantageously provides for the managed software memory 10 to be managed in such a way that programs defined as completed cannot be modified. If the exemplary user 30 then applies modifications to the control device of the technical equipment 26 which, for example, require a change in the values of environmental variables in the program 12 for the program to continue to function on the control device of the technical equipment 26, this can be enabled in the case of the system described herein by the user 30 adapting the description file 20. The description file 20 contains, for example, corresponding values for environmental variables which are transferred to the program 12 when the program 12 is called by the control device. Even though the program 12 itself remains unmodified, the user can nevertheless adapt the program 12 in line with modifications applied to technical equipment of the user.

In the example shown, not only the program 12 with the associated description file 20, but also the program 14 and the description file 22 assigned to the program 14 are assigned to the digital representation 16 of the technical equipment 26. In the example shown, the program 14 has been created by the user 34. In the example shown, the right to define the program 14 as completed can be granted accordingly to the user 34. The user 30 then advantageously only requires access to the description file 22 in order to adapt the communication behavior of the program 14 to the control device of the technical equipment 26 using the description file 22, for example by changing the port numbers which are stored as values for environmental variables in the description file 22.

As a result, the software developer 34 can create a program and make the program available as unmodifiable binary code to other users, but the other users can simultaneously gain control of the communication behavior of the respective copy of the program 14 on their technical equipment by adapting the respective description file.

In the example shown, the program 14 is further assigned to the digital representation 18 of the technical equipment 28. As in the example shown, access rights to access the digital representation 18 and the description file 24 can be assigned to the user 32, who belongs to the company 38 operating the technical equipment 28. The user 32 can thus adapt the description file 24 in order to ensure compatibility between the program 14 and the technical equipment 28.

The user 34 can in turn grant corresponding authorizations to the users 30 and 32 in order to enable the users 32 and 30 to assign the program 14 to the digital representations 16 and 18 of the technical equipment 26 and 28, respectively. Granting corresponding authorizations can be done, for example, through an individual assignment of a corresponding access right. However, granting corresponding authorizations can also be enabled by the user 34 defining the program 14 as public. The program thus defined as public can be used by all users, i.e., in particular, the program can be assigned to digital representations of technical equipment and transferred as a copy onto the control devices of technical equipment. Alternatively, in the system described herein, the user 34 can define the program 14 as group-public for a specific user group to which the users 30 and 32 can belong, as a result of which the program 14 can be used by users of the specific user group.

The features of the invention disclosed in the preceding description, in the drawing and in the claims can be essential both individually and in any combinations for the realization of the invention in its different embodiments. The invention is not limited to the described embodiments. The invention can be varied within the scope of the claims and taking account of the knowledge of the relevant person skilled in the art.

1. A method for providing programs for control devices of technical equipment, comprising:
providing the programs in a software memory managed by software memory management software, wherein the software memory management software includes access rights management and wherein the access rights of users to access the programs in the managed software memory are managed using access rights management and wherein access rights granted to users enable the users to store programs created in the managed software memory; and
one of the users granting access rights to other ones of the users enabling the other ones of the users to use specific programs provided in the software memory.

2. The method of claim 1, wherein the programs in each case include a binary file.

3. The method of claim 1, wherein at least some of the programs are definable as completed only by at least one of the users that is authorized to define at least some of the programs as completed.

4. The method of claim 3, wherein the programs defined as completed cannot be modified.

5. The method of claim 3, wherein only copies of programs defined as completed are transferrable from the managed software memory onto control devices of technical equipment and wherein copies of programs not defined as completed are transferrable from the managed software memory only under separately defined conditions.

6. The method of claim 1, wherein at least some of the programs are definable as discontinued only by at least one of the users that is authorized to define at least some of the programs as discontinued.

7. The method of claim 6, wherein copies of discontinued programs are transferrable from the managed software memory onto control devices of technical equipment only until a point in time set for the discontinued programs and wherein a notification of discontinuation is issued to at least some of the users.

8. The method of claim 1, wherein at least some of the users are granted access to the managed software memory enabling the at least some of the users to create digital representations of individual technical equipment in the managed software memory.

9. The method of claim 8, wherein the programs are stored in the managed software memory only by a subset of the users authorized to store programs in the managed software memory, wherein one of a plurality of description files is assigned to a digital representation of technical equipment and to one of the programs assigned to the one of the plurality of digital representations.

10. The method of claim 1, wherein information relating to the programs includes values of environmental variables, port numbers and/or port mapping, wherein the values of the environmental variables, the port numbers and/or the port mapping are transferred to at least one of the programs during the execution of the at least one of the programs by a control device.

11. The method of claim 10, wherein, in response to a request, a subset of the programs assigned to a digital representation of technical equipment and description files assigned to the subset of the programs and to the digital representation are synchronized using the software memory management software with the copies of the subset of the programs stored in a control device of the technical equipment with the copies of the description files stored in the control device of the technical equipment.

12. The method of claim 1, wherein at least some of the programs are definable by at least one of the users as public only if the at least some of the programs are defined as completed and wherein programs defined as public are useable by any of the users.

13. The method of claim 1, wherein at least some of the programs are definable as group-public for a specific user group only if the at least some of the programs are defined as completed wherein programs defined as group-public are useable by users belonging to a corresponding user group.

14. The method of claim 1, wherein at least some of the programs are definable as public and/or group-public only if the software memory management software establishes that specific software components contained in the at least some of the programs and/or assigned to the at least some of the programs are present and wherein, following definition of one of the programs as public and/or group-public, information contained in the software components is made available to users authorized to use the one of the programs.

15. The method of claim 1, wherein value indications assigned to the programs are used to enable a commercial exploitation of the programs.

16. The method of claim 1, wherein one of the users granting access rights to other ones of the users enables the other ones of the users to transfer a copy of at least one of the programs provided in the managed software memory onto a control device of technical equipment.

17. The method of claim 1, wherein at least some of the programs are created using a development environment.

18. The method of claim 1, wherein the separately defined conditions include experimental purposes.

19. The method of claim 8, wherein the digital representations are created using planning software for planning of the technical equipment.

20. The method of claim 9, wherein the one of a plurality of description files contains information relating to the one of the programs.
